(19) United States
(12) Patent Application Publication
(10) Pub. No.: US 2016/0379324 A1
(43) Pub. Date: Dec. 29, 2016

(54) INTERNET BASED TIER SALES AND DISTRIBUTION OF EMPLOYEE EDUCATIONAL TRAINING, WEBISODES AND RELATED MATERIALS FOR LOSS PREVENTION OR SALES TRAINING

(71) Applicant: Ken Hantman, Huntingdon Valley, PA (US)

(72) Inventor: Ken Hantman, Huntingdon Valley, PA (US)

(21) Appl. No.: 14/753,194

(22) Filed: Jun. 29, 2015

(51) Int. Cl. G06Q 50/20; G06Q 40/00; G06Q 20/12; G06Q 30/06

(52) U.S. Cl. CPC G06Q 50/2057; G06Q 30/0635; G06Q 40/12; G06Q 20/127; G06Q 20/123

(57) ABSTRACT

A method for a producer/seller of educational materials including webisodes, dealing with loss prevention, to sell such materials via security integrators, human resource outsourcers, and other services providers to end-user businesses that are clients of the integrators, human resource outsourcers or services providers. A method for such integrators, human resource outsourcers or service providers to sell such training materials to their end-user clients. The method involves identification of tier resellers, selling of a subscription basis training series mainly accessible via password protected online access to, generally, SCORM compliant formatted high production quality video and a method for capitalizing on a vast threshold between demand and supply and availability and economic feasibility of producing such high quality materials.

### CROSS-REFERENCE TO RELATED APPLICATIONS

This application is based on U.S. Provisional Application No. 61/998,804, filed Jul. 9, 2014.

### BACKGROUND OF THE INVENTION

Field of Invention

This invention relates to a method for sales and distribution of employee training via a tiered approach utilizing security integrators or utilizing human resource outsourcer providers, incorporating a technology of subscription based, internet hosted, password accessible materials. The classification 705 was searched as well as non-USPTO web based searching and no related applicable prior art was found.

Prior Art

Industry spends approximately $1200 per employee per year on training (in 2015). Various methods of training include in person presentations, consulting, webinars, books, DVD's and pamphlets. An outside presenter or creator of material or seller will generally sell this to a company's Human Resources Department which generally handles employee training, or to a particular department such as Sales, Safety & Security, Production and so forth, concerned with the topic covered.

A great inefficiency was discovered in this system and this led to the invention of the present method. The method of the present invention is based on identifying an intermediary provider of services to the categories of end-user businesses which constitute the appropriate target audiences for the materials and utilizing existing technologies of web-hosted, password protected synchronous and asynchronous access for subscribers. As such the present invention advances the commercial interaction with computer based technologies, in this case for paid educational purposes and training.

Accordingly, for training on safety, security, and loss prevention related to reducing worker's comp claims, public liability claims, external and internal theft, sickness at the workplace, defusing of violent confrontations at the workplace, and related topics, the first step of this method is to offer materials of a subscription basis to the several dozen largest security integrators in the world. Security integrators have sought to expand the range of their services from simple security to communications such as nursing station to doctor, work dock to administration office, and field offices to internal offices as well as emergency announcement systems, telephone systems and all forms of data integration. Further such companies may concern themselves with building automation, access control, guard and safety-escort services, cyber security and personal safety and emergency response systems.

Since integrators wish to provide a total experience for their clients and be viewed as valuable partners, the integration of an array of valuable training which these integrators may conduct to their clients fits their agenda. Human resource outsourcer companies such as ADP and Insperity also broaden their services provided such as payroll and employee benefit services to include providing educational employee training materials to their clients. The skills of such integrators and outsourcers to develop and produce top quality educational material on their own however is very limited and an examination of many things offered reveals a complete absence of anything of high production value quality or dramatic arts. Instead, dry, jargon-laden dreary webisodes, webinars, whitepapers and Power Point presentations prevail.

In the case of the security integrators such offered educational materials would pertain to loss prevention. In the case of the human resources outsources such materials would pertain to loss prevention and may also relate to sales training, customer service and employee communications skills.

### OBJECTS AND ADVANTAGES

Despite the good efforts of OSHA, insurance company loss prevention inspectors, in-house company loss prevention, safety and security directors, educational materials available for free online or in libraries, and the efforts of consultants to business, businesses lose about ten percent of their revenues to multiple sources of loss including workers comp incidents both traumatic and non-traumatic and the consequential damages thereof, sickness at the workplace decreasing productivity, internal and external theft, vandalism, arson, sabotage, workplace violence and slip and falls and other public liability related losses. This excludes fraud, embezzlement and work-related motor vehicle losses.

Businesses today in 2014 are earning a historically high 10% profit before taxes, up from about 6% which more typically prevailed over decades. OSHA has been effective in cutting workers comp incidents, yet a threshold of improvement has been reached where the 10% of revenues aggregate losses persist. So this means that businesses are on average earning 20% and losing about half to the areas of loss described above.

Safety training, for example, may be implemented by safety inspectors giving so-called tool box safety talks at construction sites. Yet the positive effect of such talks can be completely undermined if upon the inspector leaving the group of assembled workers one of them makes a sarcastic remark at the expense of the absent inspector. The definition of what is macho or not is thus rendered by the worst element of the group and the practical effect of the training is destroyed. The effectiveness of written brochures or canned instructional films to overcome this real psychological dynamic is obviously extremely limited. This is particularly true given that the production values of typical employee training materials is very low. A lecturer may be standing at a podium with drapes behind him or her on a stage. Power Point charts may be presented. This competes very poorly with the dramatic, super high-quality values of Hollywood and TV films, yet that is the standard against which a viewer's attention is challenged.

The typical company does not have the resources either of capital, time or skill to produce truly high-quality training materials or to originate materials beyond what is already well known.

There exists at least two industries, security integrators and human resource outsourcers, which strive to provide multiple services to their clients. Yet they in turn lack the resources to originate or produce high production values materials. Other groups or bodies that currently disseminate such materials include chambers of commerce, trade associations, trade journals, online schools and industry groups.

The present invention takes advantage of the potential of these integrators and outsources that exist between end-user companies and producers of high quality materials. In this way, based on the large numbers of end-users in a tier sale and distribution via the integrators and outsourcers, it becomes economically feasible for a seller/producer to create and provide and for an end-user company albeit relatively small to obtain very high level training materials. For this to work it is essential that the technology of web-hosted high-definition password protected access be utilized and this technology enables this application. The method and application is not and has not been in use and yet it offers a true way to save businesses a substantial portion of profits and to save lives, prevent injuries, prevent losses and improve the quality of life of employees, managers and business owners. As a consequence of that jobs are more secure, promotions more readily available, businesses can grow and be spared disruption, and the economy of the nation can prosper.

This method is based on the discovery of a particular gap or threshold between supply and demand, itself a rare event, where this potential has not been utilized. It is particular to the major security integrator and the human resource outsourcing industries and for the supply of safety and security materials, and in the case of the human resource outsourcing companies also applies to sales and communications training.

An obstacle overcome in former training or that based solely on non-interactive formats such as training films, c.d.'s, or broadcasts, is that employees quickly lose the benefits of training if they do not personally engage in it in a hands-on way. Unless the presentation is very high quality it does not engage the attention of the audience and employees merely tolerate such training as a loathsome imposition or a boring session for which they must brace themselves. By contrast, in the method proposed very high level production values and post-production editing can be done. Additionally on-site practice is done and those employees most enthusiastically engaged can have their creative contributions distributed to the whole group via technologies of web-based interaction and hosted distribution. This helps to weave the audience and the presenters together but always managed through the high production value media and techniques chosen by the producers.

Accordingly actual affective and cognitive training can be accomplished in this way changing the way employees see themselves, their co-workers and their company. New skills, confidence and creativity can be evoked. Only through the massive tier-level structured distribution defined in the method of the present invention of business method is this possible and practical. Efforts of an individual security integrator or human resource provider will otherwise inevitably fall short in this respect and heretofore has fallen short. The primary focus and duty of such integrators and human resource outsourcers, respectively, is to provide security to a client or to provide human resource services such a payroll or employee benefits. Hence truly high quality, immersive training has not been possible.

Recognizing the emergence of this unique market approach within the security integration and human resource outsourcing industries the present invention is designed to fulfill a need that exists but which has been wanly developed and not commercially capitalized upon, namely the educational services and employee training of end users of the major integrators' and human resource outsources' services. Training, when offered by these companies, has traditionally been usually offered free or is of a specific limited nature offered to individual clients.

Use of web-accessed portal hosting SCORM (Sharable Content Object Reference Model) compliant e-learning modules which can integrate with the client's LMS (Learning Management System) or stand alone, and which restricts use by way of issued passes, combined with the tier-distribution of these materials makes it for the first time possible to deliver tangible, concrete high-production value, high-definition materials to employee learners in the subject areas in an economically feasible way.

### SUMMARY

A business method in which web-based technology to limit access by password is administered on a subscription basis to view high definition training webisodes and is sold on an add-on basis to existing service contracts of security integrator and human resource outsourcing companies to their client bases is described whereby a much higher level of production values is made affordably practical for such training as received by the ultimate end-user customers. No prior method allowed or achieved such training capable of affective, cognitive and knowledge, skill and technique sets, further permitting quantification of results and observation of behavior and feedback.

### DESCRIPTION

The present invention has its first step in identifying the major integrators and human resource outsourcers.

The second step is to offer a demo video available for online password limited, time-limited access, or made available by other means such as a c.d. copy or in-person presentation on a salesperson's laptop computer. Citrix or We Transfer or SCORM Cloud of Rustici Software or other services exist to host such high definition videos and provide password and time limited access to those granted permission. Additional useful information such as the number of times viewed if permitted for unlimited views over a limited time span, whether the full demo was viewed or what portion thereof, and answers to polling questions if so configured, are available through some of these services. The integrator and human resource outsourcers may now preview the high quality nature of the material. This should convey some useful and essential information on a selected topic of pressing current interest but it should not give away the full range of solutions pertinent to that topic. It is in essence an intro or teaser yet it is not simply a commercial or advertisement. It is preferably a carefully edited extract of salient points so that the five or ten minutes spent viewing it should itself provide meaningful educational learning. An ideal embodiment might be six minutes in length.

Step Three is forming an agreement whereunder the integrator or human resource outsourcer agrees to provide the series of training videos and associated materials to all of its clients on a no risk basis but to bill them for the added service and to pay over a portion of that amount to the seller/producer of the materials. Accordingly, if the integrator or human resource outsourcer is billing a client an average figure of, for example, $20,000 per month they may add this service for $500 extra which is an entirely nominal figure. For a typical client with 500 employees this is only $12 per year per employee, which compared to the typical $1200 per year spent on employee training is vanishingly small. Yet the topics are the most vital to the interest of that end user client. In this step the integrator or outsourcer also agrees to pay a portion of the proceeds, for example twenty-five percent, to the seller/producer of the materials and may agree to added optional ancillary services or materials. In the preferred embodiment of this step the integrator or outsourcer does not solicit a buying decision from its clients but simply announces that an invaluable service has been discovered and is being added to the monthly services on a no-obligation trial basis and at a discounted cost. Due to the quantity of end-users so aggregated in this tier based sale it is possible to greatly discount the cost compared to if it was simply sold directly to single end-user companies.

Step Four is granting permission to any end user customer company that if it wishes to discontinue the monthly webisodes it simply notifies the integrator or human resource outsourcer within 30 days of the first one and the $500 billed in the example or whatever amount was in fact billed would be refunded in full. In the absence of such notice the subscription will continue to be fulfilled with monthly services and the cost of this added to the customer' invoices. If at any future time the service is to be discontinued notice will immediately stop the program, so there is 100% satisfaction guaranteed. In a preferred embodiment of this step the integrator or human resource outsourcer may send courtesy reminder notices following either the first, several or each webisode asking their client if they were satisfied or do they wish to cancel. This eliminates any sense of an imposed sale or hidden cost of services and it engages the end-user clients' endorsement and ratification and emphasizes that the end-user is completely free to accept or reject the provision of the training materials.

Step Five is the provision of a series of high quality high definition fully produced webisodes available for synchronous viewing by employees of an end-user customer, namely where all employee of that company would view the material at the same time, or asynchronous viewing as the end-user customer may prefer, for an unlimited or limited number of viewings as the subscription contract may provide. Additionally materials are provided for a recruited or delegated employee, referred to as “a deputized internal champion” of the end-user company to conduct on-site practice sessions following provided guide books and with available full-time access to the seller/producer of the materials or its expert(s) to answer facilitation or customization questions. Further, collaborative teams may be formed to further practice, apply and develop the materials. Additionally on-site expert consultation may be deployed for the fees charged or for additional fees on an as-needed basis directed by the end-user. To accomplish Step Five the integrator or human resource outsourcer must obtain from its clients the i.p. addresses or e-mail addresses of employee end-users if individualized testing results are desired, or if confidentiality of such information is preferred then a system of limited number anonymous passes is available through Citrix ShareFile.

Step Six is to provide a medium for interaction using Google Hangouts, Citrix Go to Training, Podio, webcam videos and other communicative and interactive web-based media to allow employees to present their ideas to the whole group as guided by the process. This creates an immersive training experience spread over time. Such videos may also be incorporated or embedded in future produced webisodes.

Step Seven is the observation and evaluation of testing given on the materials utilizing the polling and automatically generated survey functions of Citrix Go to Webinar or other hosting sites and services. Internal evaluation by the recruited so-called internal champion or employee leader of the training further extends the ability to assess and quantify not only reaction to the materials but real change in the employees. The measuring of affective and cognitive changes as opposed to simply the acquisition of knowledge, skills or techniques can in this way be accomplished.

Step Eight is the accounting of the economic consequences of the capitalization of this method described above which at the first casual estimate may seem to yield very small potential. But in fact an integrator or human resource outsourcer may have 5000 end user clients which average 500 employees each. Accordingly the simple method above produces a gross receipt of $30M. This is from one integrator or human resource outsourcer. The integrator or human resource outsourcer would be paid ¾ of this and the seller/producer ¼.

Step Nine is the distribution of the income which can be ¾ to the integrator or human resource outsourcer and ¼ to the seller/producer. This assures a strong profit to the integrator or human resource outsourcer which has no cost to invest to develop, host or distribute the series.

This method is based on the discovery of a particular gap or threshold between supply and demand, itself a rare event, where this potential has not been utilized. It is particular to the major security integrator and the human resource outsourcing industries and for the supply of safety and security materials, although in the case of human resource outsourcers it may also apply to the distribution of sales training materials.

### CONCLUSION, RAMIFICATION AND SCOPE OF INVENTION

Thus the reader will see that the business method and instrumentality of the invention provides a fulsome, effective and needed educational opportunity for many employees and provides an unexploited capitalization of existing web technology and an activation of previously unutilized potential for profits in the existing structural arrangement of large security integrators and human resource outsourcers to their clients.

While our above description contains many specifications these should not be construed as a limitation on the scope of the invention, but rather as an exemplification of one or more preferred embodiments thereof. Where specific numbers are given ranges of numbers may as well be applicable depending on particular circumstances. Many other variants are possible. For example other distributors of educational materials such as online universities, trade organizations, chambers of commerce, insurance companies and trade journal media may implement the methods of this invention.

Variations from the preferred embodiment may involve substitution of 3D virtual world training environments for the high-definition webisodes and of telephone conferences for the Google Hangouts, and so forth.

Accordingly, the scope of the invention should be determined not by the embodiment(s) but by the appended claims and their legal equivalents.

1. A method for a producer/seller of educational materials dealing with loss prevention including webisodes, to sell said materials via security integrators, human resource outsourcers, and other services providers to end-user businesses that are clients of said integrators or human resource outsourcers or services providers, comprising the steps of:
a) identifying security integrators, human resource outsourcers and services providers, and
b) offering a demo video of one or more webisodes for review, and
c) forming an agreement with said security integrators, human resource outsourcers or service providers wherein the said integrators, outsourcers or service providers provide to their clients the said webisodes and materials on a paid subscription wherein a cost is charged for said subscription is small relative to the monthly billings of said integrator, outsourcer or service provider to said end-user client, and
d) granting permission to said end-user clients to discontinue said subscription without charge for first said webisode or to discontinue said subscription at any subsequent time without charge for any future services thus terminated, and
e) providing a series of high quality webisodes and associated training materials to be hosted on a website capable of offering password protected or otherwise limited access, and
f) providing means selected from the group consisting of feedback, polling, surveys, collaborative groups, on-site training, customization, webcam or live presentations or Google Hangouts or other video conferencing by employees receiving training with other employees receiving training or with said provider/seller or its expert or experts, consultation with the producer/seller or its expert or experts, to facilitate the training, and
g) providing a means of observation and evaluation or testing of results selected from the group consisting of Citrix Go to Webinar, Citrix ShareFile, SCORM Cloud of Rustici Software, or other hosting sites and services, and
h) providing availability of on-site training by deputized internal champions, selected representatives or group leaders, and
i) accounting of revenues generated by the subscription services and
j) distribution of said revenues wherein a larger portion of said revenues is paid to said integrators, outsourcers or service providers and a smaller remaining portion to said producer/seller of said educational materials, and
whereby a great unexploited resource of potential income may be realized while at the same time providing said end-user clients with an excellent value for a valuable, needed service.

2. A method for a security integrator, human resource outsourcer, and other services provider to sell educational materials dealing with loss prevention including webisodes, to end-user businesses that are clients of said integrators or human resource outsourcers or services providers, comprising the steps of:
a) offering a demo video for review, and
b) forming an agreement with said clients to provide said webisodes and materials on a paid subscription wherein the cost of said subscription is small relative to the monthly billings of said integrator, outsourcer or services provider to said end-user client, and
c) granting permission to said end-user clients to discontinue said subscription without charge for first said webisode or to discontinue said subscription at any subsequent time without charge for any future services thus terminated, and
d) providing a series of high quality webisodes and associated training materials to be hosted on a website capable of offering password protected or otherwise limited access, and
e) providing means selected from the group consisting of feedback, polling, surveys, collaborative groups, on-site training, customization, webcam or live presentations or Google Hangouts or other video conferencing by employees receiving training with other employees receiving training or with said provider/seller or its expert or experts, consultation with the producer/seller or its expert or experts, to facilitate the training, and
f) providing a means of observation and evaluation or testing of results selected from the group consisting of Citrix Go to Webinar, Citrix ShareFile, SCORM Cloud by Rustici Software or other hosting sites and services, and
g) providing deputized internal champions, selected representatives or group leaders, and
h) receiving revenues generated by the subscription services
whereby a great unexploited resource of potential income may be realized while at the same time providing said end-user clients with an excellent value for a valuable, needed service.

3. A method for a human resource outsourcer, and other services provider to sell educational materials dealing with sales and communication skills including webisodes, to end-user businesses that are clients of human resource outsourcers or services providers, comprising the steps of:
a) offering a demo video for review, and
b) forming an agreement with said clients to provide said webisodes and materials on a paid subscription wherein the cost of said subscription is small relative to the monthly billings of outsourcer or services provider to said end-user client, and
c) granting permission to said end-user clients to discontinue said subscription without charge for first said webisode or to discontinue said subscription at any subsequent time without charge for any future services thus terminated, and
d) providing a series of high quality webisodes and associated training materials to be hosted on a website capable of offering password protected or otherwise limited access, and
e) providing means selected from the group consisting of feedback, polling, surveys, collaborative groups, on-site training, customization, webcam or live presentations or Google Hangouts or other video conferencing by employees receiving training with other employees receiving training or with said provider/seller or its expert or experts, consultation with the producer/seller or its expert or experts, to facilitate the training, and
f) providing a means of observation and evaluation or testing of results selected from the group consisting of Citrix Go to Webinar, Citrix ShareFile, SCORM Cloud of Rustici Software or other hosting sites and services, and
g) providing deputized internal champions, selected representatives or group leaders, and
h) receiving revenues generated by the subscription services whereby a great unexploited resource of potential income may be realized while at the same time providing said end-user clients with an excellent value for a valuable, needed service.
